(19) United States
(12) Patent Application Publication
(10) Pub. No.: US 2025/0331476 A1
(43) Pub. Date: Oct. 30, 2025

(54) AQUAPONICS MEDIA CLEANING SYSTEM

(71) Applicant: ARIZONA BOARD OF REGENTS ON BEHALF OF THE UNIVERSITY OF ARIZONA, Tucson, AZ (US)

(72) Inventors: Matthew S. Recsetar, Tucson, AZ (US); Devin Dafoe, Tucson, AZ (US); Thomas Gentrup, Tucson, AZ (US); Jeffrey Horwitz, Tucson, AZ (US); Colin Maroe, Tucson, AZ (US); Jeremy Sharp, Tucson, AZ (US); Lauren Vasquez, Tucson, AZ (US); Minghao Zhang, Tucson, AZ (US)

(21) Appl. No.: 19/191,937

(22) Filed: Apr. 28, 2025

Related U.S. Application Data
(60) Provisional application No. 63/639,186, filed on Apr. 26, 2024.

(51) Int. Cl. A01G 24/60; A01G 24/15; A01G 31/02

(52) U.S. Cl. CPC A01G 24/60; A01G 24/15; A01G 31/021

(57) ABSTRACT

A system for breaking down debris in a plant-supporting medium. The system includes a masticator device for breaking down the debris by a plurality of brushes. The system further includes a tumbler device fluidly coupled to the masticator device, configured to rotate and spray water to clean the plant-supporting medium and remove the debris.

### CROSS-REFERENCE TO RELATED APPLICATIONS

This application is a non-provisional and claims benefit of U.S. Provisional Application No. 63/639,186 filed Apr. 26, 2024, the specification of which is incorporated herein in its entirety by reference.

### FIELD OF THE INVENTION

The present invention is directed to an automated high-throughput process for cleaning light-expanded clay aggregate (LECA), and other similar media such as but not limited to expanded shale, lava rock, and gravel, between harvests in hydroponics systems that utilize media.

### BACKGROUND OF THE INVENTION

Aquaponics is a form of agriculture that combines raising fish in tanks (recirculating aquaculture) with soilless plant culture (hydroponics). Aquaponics often uses media such as gravel, perlite, or light-expanded clay aggregate (LECA) to grow plants efficiently and effectively. LECA has been found to be beneficial for growth of cannabis and other crops when compared to other plant-supporting media. It is not cost-effective to throw out LECA after use, but it must be cleaned after harvesting the crops to maintain its efficacy. After each harvest, however, roots and sediment from the hydroponic system are often entangled and stuck onto the LECA. These roots and sediment are difficult to clean to remove from the LECA. The process is time-consuming and all existing methods require it to be done by hand, harshly limiting the applications of LECA for commercial purposes. Thus, there exists a present need for an automated high-throughput process for cleaning LECA for aquaponics systems.

### BRIEF SUMMARY OF THE INVENTION

It is an objective of the present invention to provide devices, systems, and methods that allow for an automated high-throughput process for cleaning light-expanded clay aggregate (LECA) between harvests in hydroponics systems that utilize media, as specified in the independent claims. Embodiments of the invention are given in the dependent claims. Embodiments of the present invention can be freely combined with each other if they are not mutually exclusive.

The present invention features a masticator device for breaking down debris in a plant-supporting medium. The device may comprise a body component, an inlet fluidly coupled to an interior of the body component, configured to accept the plant-supporting medium, and a plurality of belts disposed within the interior of the body component, comprising a plurality of brushes disposed on the plurality of belts. The plurality of belts may be configured to move the plurality of brushes throughout the interior of the body component such that the debris is broken down by the plurality of brushes as the plant-supporting medium moves through the body component.

The present invention features a system for breaking down debris in a plant-supporting medium. The system may comprise a masticator device comprising a body component, an inlet fluidly coupled to an interior of the body component, configured to accept the plant-supporting medium, and a plurality of belts disposed within the interior of the body component, comprising a plurality of brushes disposed on the plurality of belts. The plurality of belts may be configured to move the plurality of brushes throughout the interior of the body component such that the debris is broken down by the plurality of brushes as the plant-supporting medium moves through the body component. The system may further comprise a tumbler device fluidly coupled to the masticator device, comprising a drum component configured to rotate on an axis, the drum component comprising a plurality of slits, a plurality of spray nozzles disposed within the drum component, fluidly coupled to a water source, configured to spray water into the drum component upon actuation, and a gate component fluidly coupled to the drum component, configured to open and close upon actuation. The system may further comprise a collection device fluidly coupled to the gate component, configured to collect the plant-supporting medium from the drum component.

One of the unique and inventive technical features of the present invention is the implementation of a masticator component comprising a plurality of brushes on belts for breaking apart clumps of roots and sediment upon initial loading of the LECA into the machine. Without wishing to limit the invention to any theory or mechanism, it is believed that the technical feature of the present invention advantageously provides for a high-throughput automated process for cleaning LECA between harvests. None of the presently known prior references or work has the unique inventive technical feature of the present invention.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a schematic diagram of the automated LECA cleaning device of the present invention.

FIG. 2A shows a front perspective view of the tumbler component of the device of the present invention.

FIG. 2B shows a back perspective view of the tumbler component of the device of the present invention.

FIG. 3 shows a method-of-use flow chart diagram of the automated LECA cleaning device of the present invention.

FIG. 4A shows a front perspective view of the automated LECA cleaning device of the present invention.

FIG. 4B shows a back perspective view of the automated LECA cleaning device of the present invention.

FIG. 4C shows a back view of the automated LECA cleaning device of the present invention.

FIG. 4D shows a side view of the automated LECA cleaning device of the present invention.

FIG. 4E shows a front view of the automated LECA cleaning device of the present invention.

FIG. 4F shows a bottom view of the automated LECA cleaning device of the present invention.

FIG. 5 shows a state diagram of the user interface of the present invention.

FIG. 6A shows a schematic diagram of a masticator device of the present invention.

FIGS. 6B-6C show schematic diagrams of a plant-supporting medium with debris being directed through the masticator device such that the debris is broken down from the plant-supporting medium by the brushes on the belts.

FIG. 7A shows a schematic diagram of a system for automatically removing debris from a plant-supporting medium.

FIGS. 7B-7D show schematic diagrams of a plant-supporting medium with debris being directed through the system of the present invention such that the debris is broken down, removed from the plant-supporting medium, and collected while the plant-supporting medium is cleaned and also collected.

FIG. 8 shows a flow chart of a method for breaking down and removing debris from a plant-supporting medium.

### DETAILED DESCRIPTION OF THE INVENTION

Following is a list of elements corresponding to a particular element referred to herein:
100 masticator
110 body component
120 inlet
130 belts
135 brushes
200 tumbler
210 drum component
215 slits
216 collection pan
220 spray nozzles
230 gate component
300 collection device
310 finishing spray nozzles
1000 system

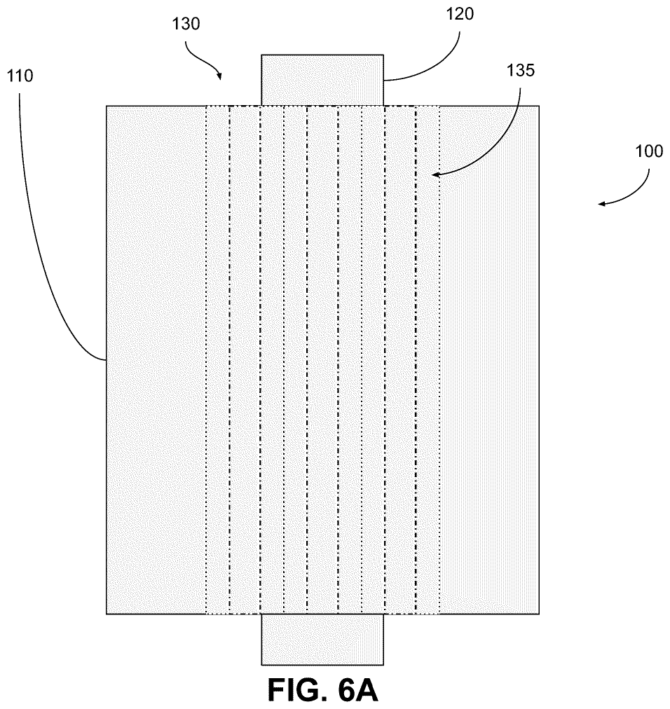

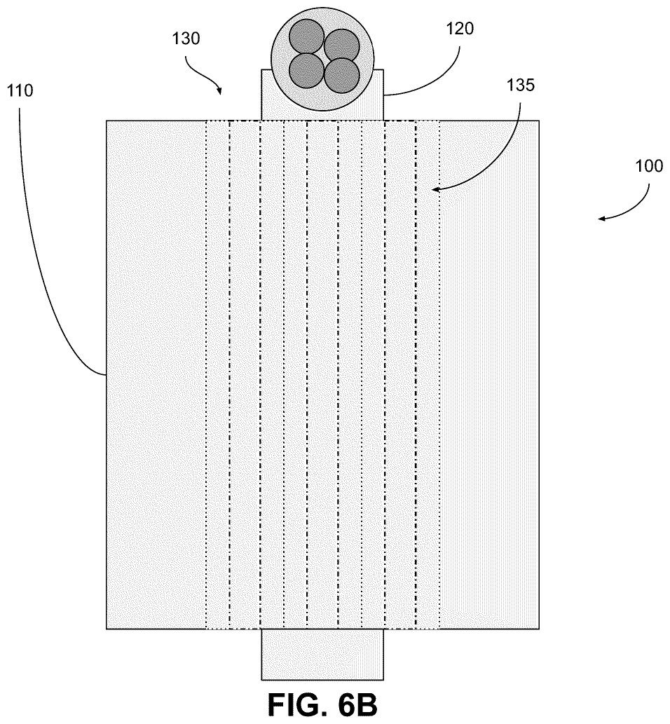

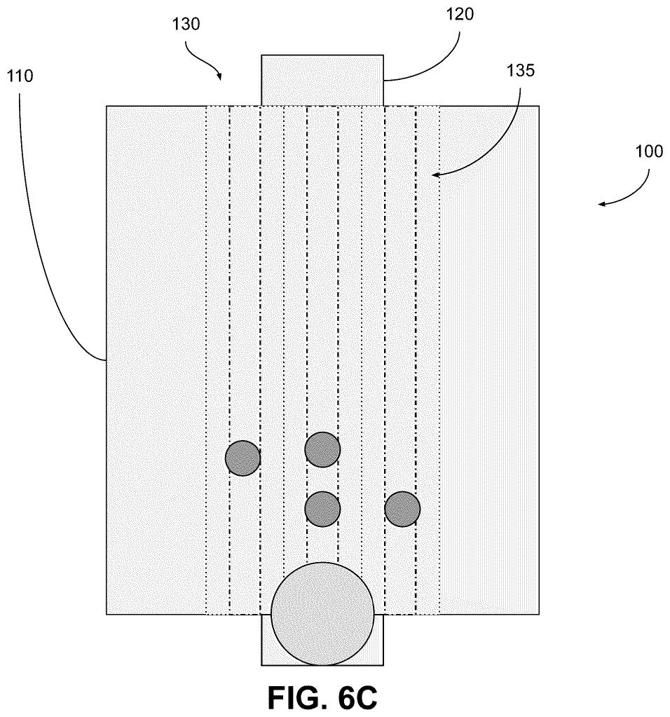

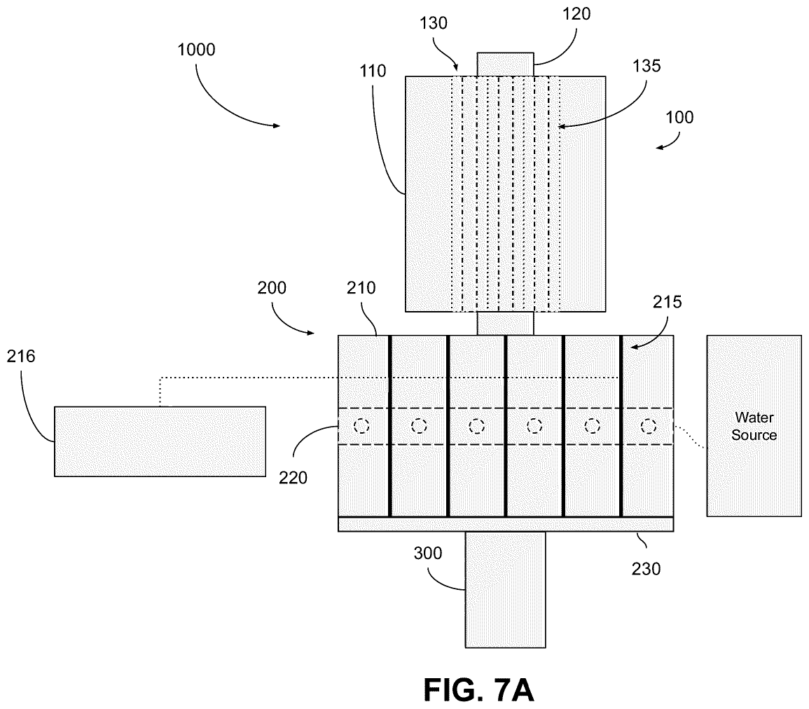

Referring now to FIGS. 6A-6C, the present invention features a masticator device (100) for breaking down debris in a plant-supporting medium. In some embodiments, the device (100) may comprise a body component (110). The device (100) may further comprise an inlet (120) fluidly coupled to an interior of the body component (110), configured to accept the plant-supporting medium. The device (100) may further comprise a plurality of belts (130) disposed within the interior of the body component (110), comprising a plurality of brushes (135) disposed on the plurality of belts (130). The plurality of belts (130) may be configured to move the plurality of brushes (135) throughout the interior of the body component (110) such that the debris is broken down by the plurality of brushes (135) as the plant-supporting medium moves through the body component (110).

In some embodiments, the device (100) may further comprise a motor operatively coupled to the plurality of belts (130), configured to move the plurality of belts (130) upon actuation. In some embodiments, the body component (110) may comprise a stainless steel material. In some embodiments, the debris may comprise roots, sediment, or a combination thereof. In some embodiments, the plant-supporting medium may comprise lightweight expanded clay aggregate (LECA), expanded shale, lava rock, gravel, or a combination thereof.

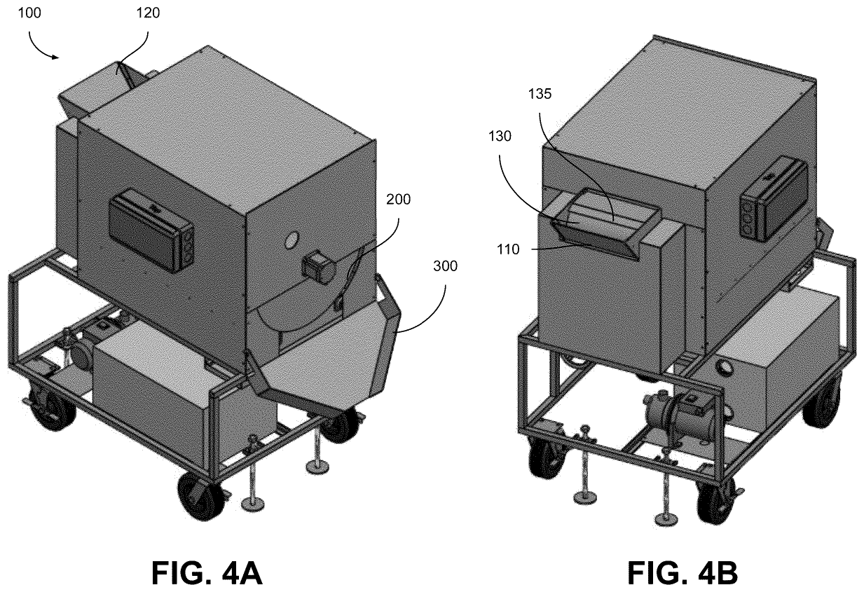

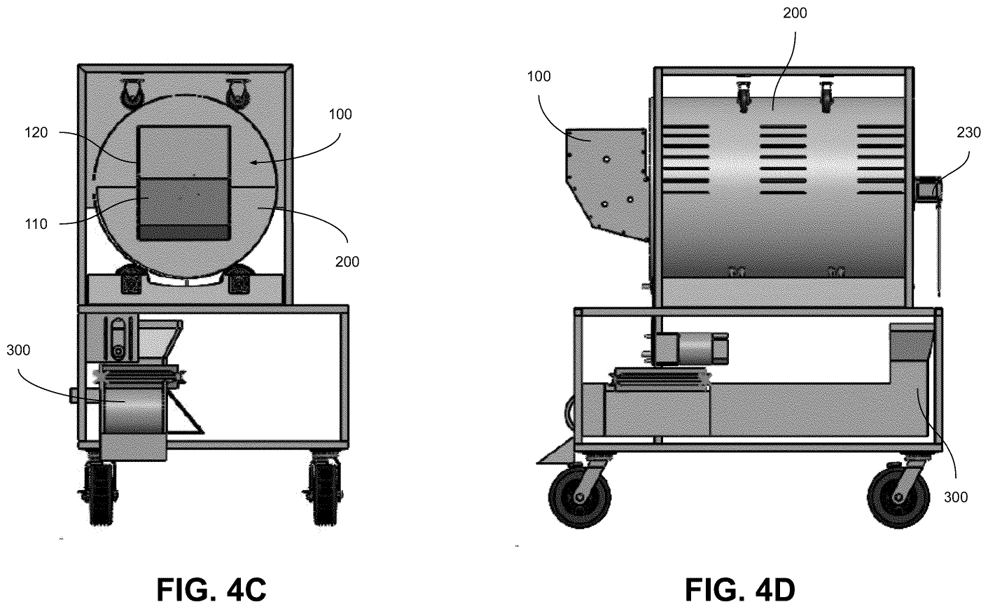

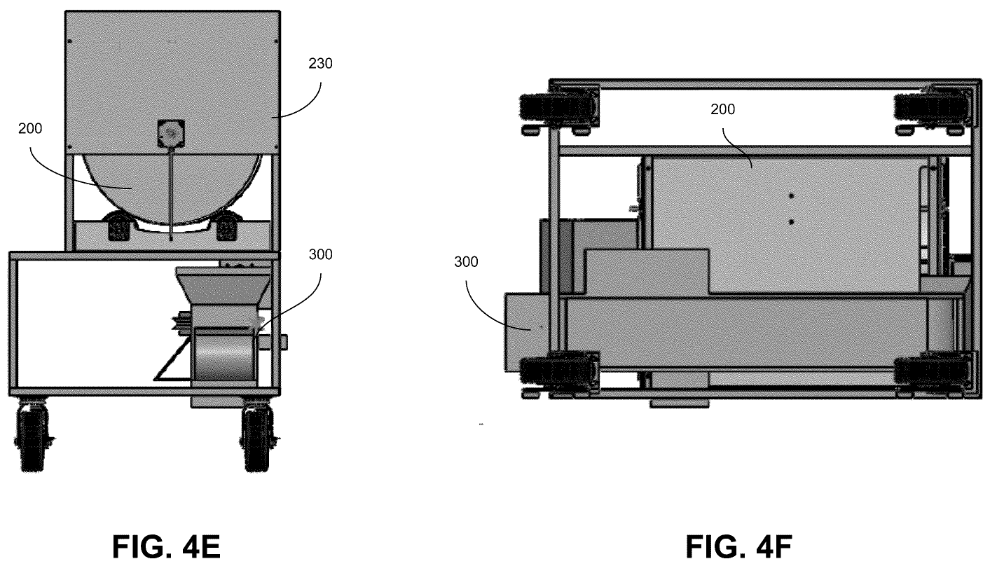

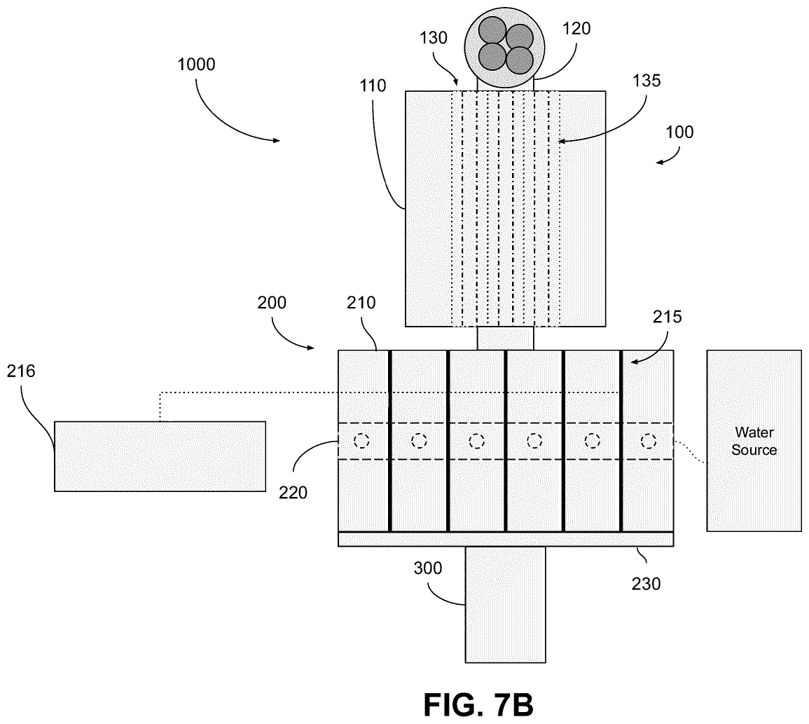

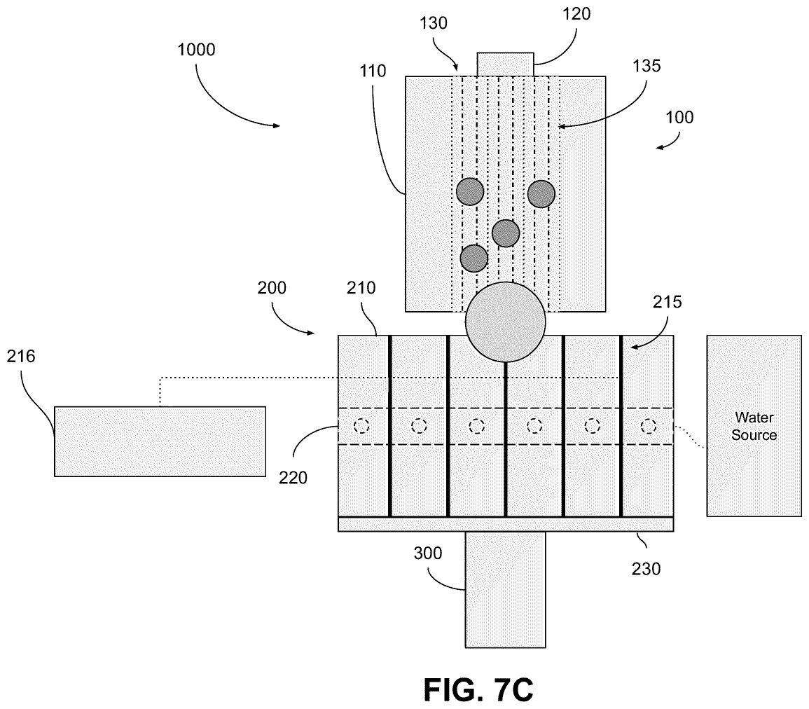

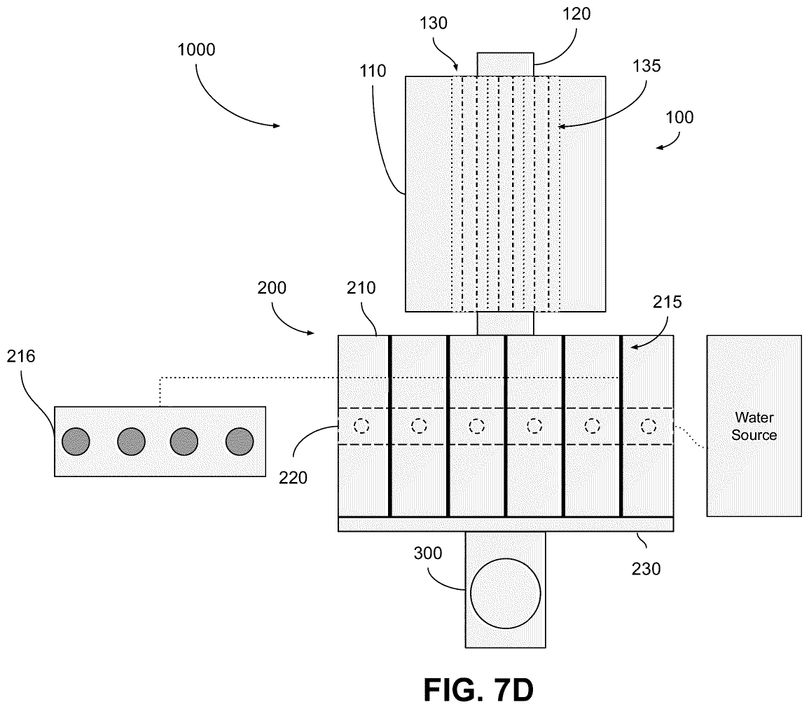

Referring now to FIGS. 7A-7D, the present invention features a system (1000) for breaking down debris in a plant-supporting medium. In some embodiments, the system (1000) may comprise a masticator device (100). The masticator device (100) may comprise a body component (110), an inlet (120) fluidly coupled to an interior of the body component (110), configured to accept the plant-supporting medium, and a plurality of belts (130) disposed within the interior of the body component (110), comprising a plurality of brushes (135) disposed on the plurality of belts (130). The plurality of belts (130) may be configured to move the plurality of brushes (135) throughout the interior of the body component (110) such that the debris is broken down by the plurality of brushes (135) as the plant-supporting medium moves through the body component (110). FIGS. 4A-4F additionally depict the masticator device (100).

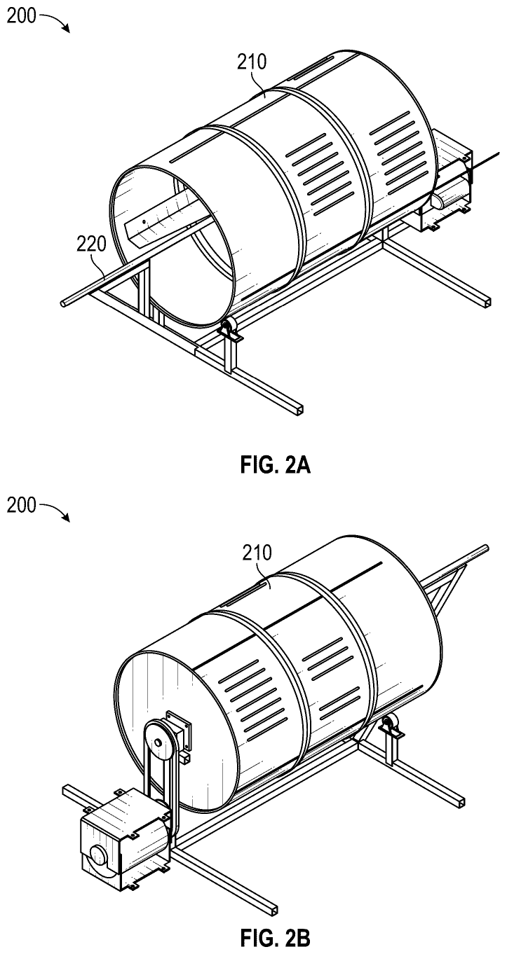

The system (1000) may further comprise a tumbler device (200) fluidly coupled to the masticator device (100) such that the plant-supporting medium exits the body component (110) and enters the tumbler device (200). The tumbler device (200) may comprise a drum component (210) configured to rotate on an axis, the drum component (210) comprising a plurality of slits (215), configured to allow the debris to exit the drum component (210). The tumbler device (200) may further comprise a plurality of spray nozzles (220) disposed within the drum component (210), fluidly coupled to a water source, configured to spray water into the drum component (210) upon actuation such that the plant-supporting medium is cleaned. The tumbler device (200) may further comprise a gate component (230) fluidly coupled to the drum component (210), configured to open and close upon actuation, such that the plant-supporting medium exits the drum component (210) through the gate component (230). FIGS. 2A-2B additionally depict the tumbler component (200). The system (1000) may further comprise a collection device (300) fluidly coupled to the gate component (230), configured to collect the plant-supporting medium from the drum component (210). In some embodiments, the drum component (210) may comprise one or more internal fins disposed within the drum component (210), configured to lift and mix the plant-supporting medium.

In some embodiments, the system (1000) may further comprise a motor operatively coupled to the plurality of belts (130), configured to move the plurality of belts (130) upon actuation. In some embodiments, the body component (110) and the drum component (210) may comprise a stainless steel material. In some embodiments, the debris may comprise roots, sediment, or a combination thereof. In some embodiments, the system (1000) may further comprise a motor operatively coupled to the drum component (210), configured to rotate the drum component (210) on the axis. In some embodiments, the collection device (300) may comprise a bin, a hopper, an external device, or a combination thereof. In some embodiments, the system (1000) may further comprise a plurality of finishing spray nozzles (310) disposed within the collection device (300), fluidly coupled to the water source, configured to spray water into the collection device (300) upon actuation. In some embodiments, the collection device (300) may comprise an internal filtration system disposed within the collection device (300), configured to recirculate the water from the plurality of finishing spray nozzles (310) back into the water source.

In some embodiments, the system (1000) may further comprise a pump fluidly coupled to the water source, configured to pump the water to the plurality of spray nozzles (220), the plurality of finishing spray nozzles (310), or a combination thereof. In some embodiments, the system (1000) may further comprise a filter fluidly coupled to the water source, configured to filter the water that is directed to the plurality of spray nozzles (220), the plurality of finishing spray nozzles (310), or a combination thereof. In some embodiments, the system (1000) may further comprise one or more solenoid valves fluidly coupled to the water source, configured to control a flow of the water to the plurality of spray nozzles (220), the plurality of finishing spray nozzles (310), or a combination thereof. In some embodiments, the system (1000) may be configured to separate and collect LECA clumps of ⅛″ to ½″ in diameter.

In some embodiments, the system (1000) may further comprise a motor configured to operate the gate component (230). In some embodiments, the system (1000) may comprise an alternating current (AC) power source operatively coupled to the motors driving the plurality of belts (130), the drum component (210), and the gate component (230), the plurality of spray nozzles (220), the plurality of finishing spray nozzles (310), or a combination thereof. In some embodiments, the system (1000) may further comprise a direct current (DC) power supply operatively coupled to the AC power supply for converting the AC from the AC power supply into a DC.

In some embodiments, the system (1000) may further comprise a controller unit operatively coupled to the AC power supply, the DC power supply, the motors driving the plurality of belts (130), the drum component (210), and the gate component (230), the plurality of spray nozzles (220), the plurality of finishing spray nozzles (310), or a combination thereof. The controller unit may be configured to operate a function of these components, such as turning the motors on and off, turning the spray nozzles on and off, opening and closing the gate component, or a combination thereof. The system (1000) may further comprise a display component communicatively coupled to the controller unit, configured to display a status of the one or more components controlled by the controller unit. The system (1000) may further comprise one or more buttons operatively coupled to the controller unit, configured to allow a user to control a function of the one or more components controlled by the controller unit. In some embodiments, the plant-supporting medium may comprise lightweight expanded clay aggregate (LECA), expanded shale, lava rock, gravel, or a combination thereof.

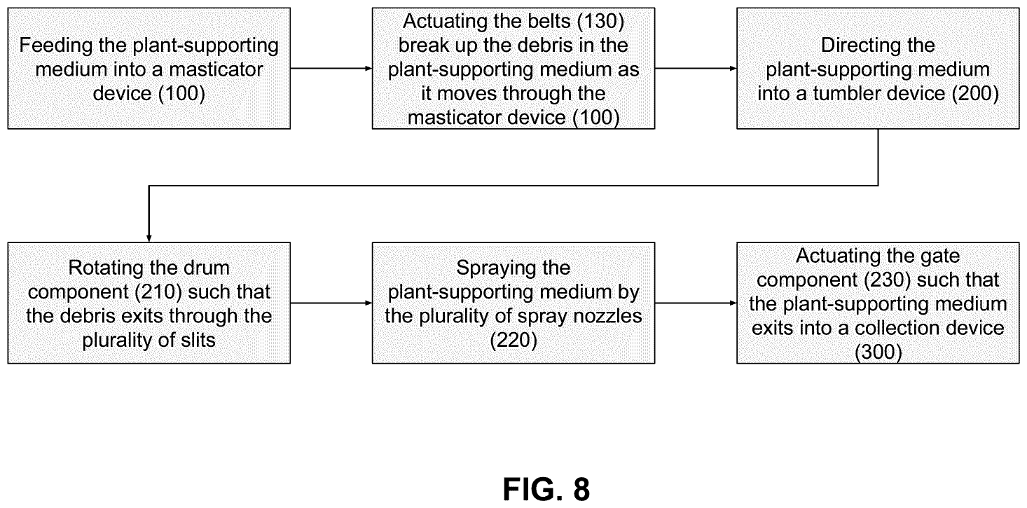

Referring now to FIG. 8, the present invention features a method for breaking down debris in a plant-supporting medium. In some embodiments, the method may comprise feeding the plant-supporting medium into a masticator device (100). The masticator device (100) may comprise a body component (110), an inlet (120) fluidly coupled to an interior of the body component (110), and a plurality of belts (130) disposed within the interior of the body component (110), comprising a plurality of brushes (135) disposed on the plurality of belts (130). The method may further comprise actuating the plurality of belts (130) such that the plurality of brushes (135) break up the debris in the plant-supporting medium as the plant-supporting medium moves through the masticator device (100), and directing the plant-supporting medium into a tumbler device (200).

The tumbler device (200) may comprise a drum component (210) configured to rotate on an axis, the drum component (210) comprising a plurality of slits (215), a plurality of spray nozzles (220) disposed within the drum component (210), fluidly coupled to a water source, and a gate component (230) fluidly coupled to the drum component (210). The method may further comprise rotating the drum component (210) such that the debris exits the drum component (210) through the plurality of slits (215), spraying the plant-supporting medium by the plurality of spray nozzles (220), and actuating the gate component (230) such that the plant-supporting medium exits the drum component (210) into a collection device (300). In some embodiments, the drum component (210) may comprise one or more internal fins disposed within the drum component (210), configured to lift and mix the plant-supporting medium.

In some embodiments, the masticator device (100) may further comprise a motor operatively coupled to the plurality of belts (130), configured to move the plurality of belts (130) upon actuation. In some embodiments, the body component (110) and the drum component (210) may comprise a stainless steel material. In some embodiments, the debris may comprise roots, sediment, or a combination thereof. In some embodiments, the tumbler device (200) may further comprise a motor operatively coupled to the drum component (210), configured to rotate the drum component (210) on the axis. In some embodiments, the collection device (300) may comprise a bin, a hopper, an external device, or a combination thereof. In some embodiments, the method may further comprise spraying, by a plurality of finishing spray nozzles (310) disposed within the collection device (300), fluidly coupled to the water source, water into the collection device (300). In some embodiments, the collection device (300) may comprise an internal filtration system disposed within the collection device (300), configured to recirculate the water from the plurality of finishing spray nozzles (310) back into the water source. In some embodiments, the plant-supporting medium may comprise lightweight expanded clay aggregate (LECA), expanded shale, lava rock, gravel, or a combination thereof.

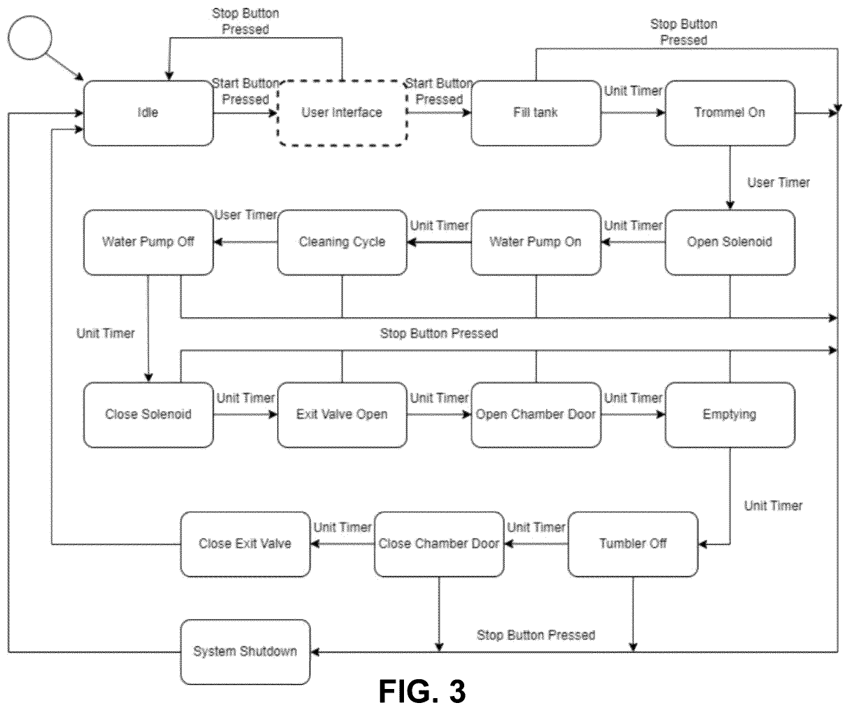

The system of the present invention may be partially viewed as a large industrial cleaning machine, however, it has several distinct functions. The system may comprise a user-directed masticator. Before the LECA is inputted into the device's hopper, the user may hold a collection of roots or plant waste that is particularly hardy, and expose them to the spinning brushes of the device. The masticator may be controlled separately from the other functions of the device, requiring a holding down of a button to prevent possible injuries from an appendage becoming drawn into the brushes. Inside the system, the LECA may enter a tumbling chamber where it will be lifted and agitated with fins of the chamber, as well as be sprayed down with water. During its operation, the system may drain the non-retained contents of the chamber, like the water and discarded root material through a bottom plate. Finally, when the device operation is finished, the system may open the tumbling chamber, allowing the LECA to enter a chute and directing the material to fall into a collection bin, clean and debris-free. The flowchart of the execution of the system of the present invention is depicted in FIG. 3.

The system of the present invention may comprise five subsystems: the mechanical subsystem, hydraulic subsystem, power subsystem, control subsystem, and waste subsystem. The control subsystem may allow the user to direct the operation of the device. Like the brain and nervous system, everything internal to the system may be able to be controlled electronically. The mechanical and hydraulic systems may be directly controlled by the control system. The mechanical system may comprise the frame, the tumbler, the masticator, and all assemblies related to the physical interaction of the device with the LECA. The hydraulic subsystem may comprise the filtration system, the pump(s), and the water hoses/nozzles. This may help the system to further separate the plant remains from the aggregate, as well as provide a method for flushing these remains out of the system. The final three subsystems—power, control, and waste—may work in tandem with the hydraulic and mechanical subsystems to direct the individual operations of the device. These systems may be viewed as the backbone of the central operations of the device, directing power and coordinating where and how the LECA is transported during the machine's operation. All together, these subsystems may take root balls leftover from an aquaponic harvest and separate the roots from the LECA.

The control system may feature a user interface so that the user can control (start and stop) both the mechanical and hydraulic systems. The mechanical system's purpose is to physically agitate all the roots and LECA and physically separate the LECA from the roots. The tumbler's main function is, like a laundry dryer, to lift and toss the LECA and associated root balls in order to let friction and gravity loosen and break them apart, while the conveyor belt's main function is to separate the LECA from the loose roots. The frame's main purpose is to allow an assembly of all the systems so that the system may be unitary, mobile and stable. The hydraulic system's main function is to assist the mechanical system in separating the roots from the LECA efficiently. This may comprise nozzles in the tumbler and on the conveyor belt. Furthermore, the frame may be modified to have a catch and drain system for water filtration and recycling so that the system can be efficient.

In some embodiments, the present invention features a tumbler assembly built from a 55 gallon steel drum with slots cut out for drainage as well as paddles welded inside for extra agitation. Short tests were performed with a dry LECA and roots combination to determine the effectiveness of a drum-(or trommel-) style tumbler.

The hydraulic subsystem is necessary to assist in the agitation of the roots and LECA in the system. The mechanical subsystem, including both the masticator and the tumbler, may also assist in the agitation of the roots and LECA. The masticator does this during the loading phase of the system by having the brushes agitate the roots from the LECA. The tumbler may agitate the roots and LECA by tumbling the LECA at around 56 RPM, similar to how a side-loading drying machine works. The purpose of this RPM is so that pieces of LECA fall to the bottom of the tumbler once they reach the vertex. Additionally, the system may be sized such that it may fit through a standard greenhouse door (80″×39″, H×W), keeping the system at or below the dimensions of 72″×36″×60″ (H×W×L). The power subsystem/control subsystem may be connected to the controller (Arduino®) Nano), which may run a script to ensure the system runs autonomously.

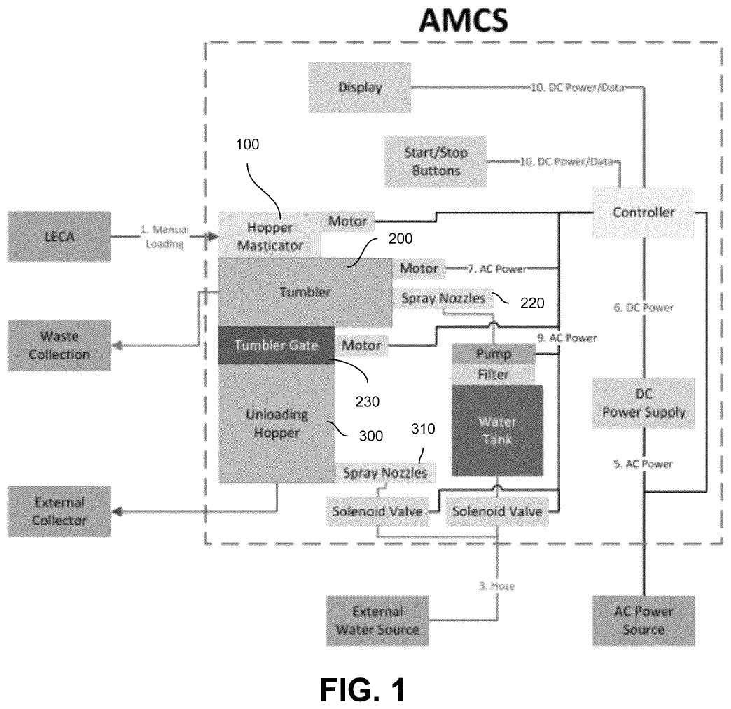

Referring now to FIG. 1, the current firmware comprises the physical user interface components, the start and stop buttons, and the physical user interface components localized to the graphical user interface, the forward/backward and increase/decrease buttons. These may begin and end the system's cleaning process by changing the initial state machine (SM) procedure. In each separate state, different components may be turned on and off according to the needs of each state. The different components may comprise: the tumbler motor, the two solenoid valves, the water pump, and the unloader stepper motor.

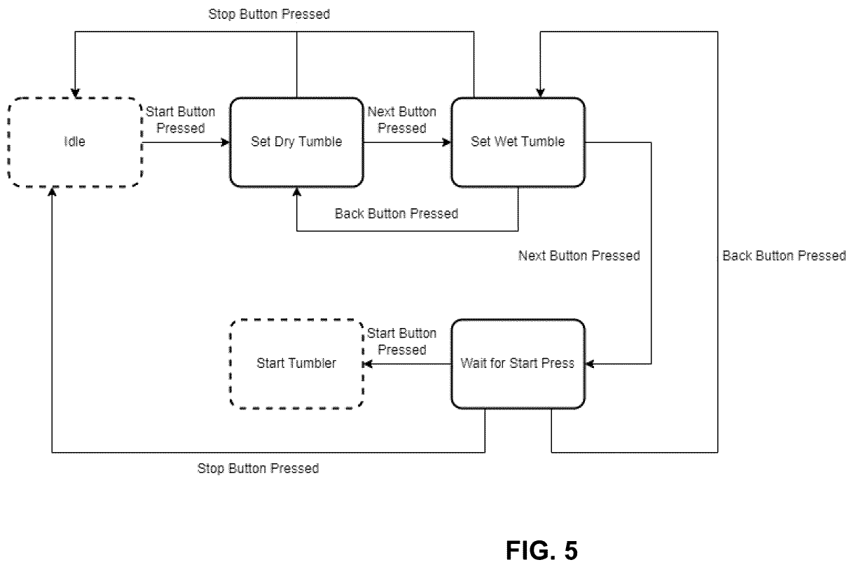

The software-implemented state machine may allow for increased flexibility in the case that additional components are added in the system's life cycle. The change in states may be driven by the user inputs and the onboard timer set through software. The design decision to use physical components like buttons may help to promote the simplicity and lifespan of the device of the present invention. These components may allow the user to turn the device on during its idle state. The off button will stop the machine in any state aside from the idle state (when it is not powering any component), powering down all components immediately. The system may further comprise a graphical user interface that receives physical user inputs, such that a user may be able to set custom times for the system-specific cycles, currently extending to the “dry tumble” and “wet tumble” phases. Before the operation of the machine, the user may be able to adjust these parameters by shifting from screen to screen on a Liquid Crystal display (LCD), changing the shown values of minutes to adjust to user preference. A flow chart of user operation of the system of the present invention is depicted in FIG. 5.

Developed by blending mechanical engineering, environmental science, and computer technology, the present invention streamlines the cleaning process, significantly reducing labor costs and water usage while enhancing operational efficiency. The present invention features an efficient masticator that begins the cleaning process by breaking apart root clumps during the initial loading phase. Following this, the soiled LECA progresses into a specially designed stainless steel tumbler adorned with ¼″ slits around its surface, effectively separating roots and debris while keeping the LECA balls securely inside. Beneath the tumbler, a waste bin collects the expelled material, with a catch drain in place to prevent the recirculated water from becoming contaminated. To ensure thorough cleaning, the tumbler is outfitted with two spray nozzles that continuously douse the LECA with water, aiding in the removal of any remaining roots or debris. The system is supported by a pump featuring an in-line filter and utilizes a 20-gallon water tank, enabling the water to be reused efficiently in the cleaning process. Lastly, the system utilizes an Arduino® microcontroller to drive the system.

In some embodiments, the masticator device (100) may comprise 1 to 10 belts (130). In some embodiments, the masticator device (100) may comprise 1 to 10 brushes (135). In some embodiments, the belts (130) may be oriented such that the brushes (135) move axially throughout the body component (110), transversely throughout the body component (110), or a combination thereof.

In some embodiments, the tumbler device (200) may comprise 1 to 20 slits (215). In some embodiments, the tumbler device (200) may comprise 1 to 50 spray nozzles (220). In some embodiments, the spray nozzles (220) may be oriented axially throughout the drum component (210), circumferentially throughout the drum component (210), or a combination thereof (e.g., a grid formation). In some embodiments, the spray nozzles (220) may be activated based on user input, computer input, or a combination thereof. In some embodiments, the debris directed through the slits (215) may be collected in a collection pan (216) beneath the tumbler device (200). In some embodiments, the gate component (230) may open and close at a constant interval. In some embodiments, the gate component (230) may open and close based on user input, computer input, or a combination thereof.

The system of the present invention may be configured to clean plant-supporting media for any hydroponics system that utilizes said media, including but not limited to aquaponics systems. In essence, it can clean media from any soilless growing system.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A masticator device (100) for breaking down debris in a plant-supporting medium, the device comprising:
a. a body component (110);
b. an inlet (120) fluidly coupled to an interior of the body component (110), configured to accept the plant-supporting medium; and
c. a plurality of belts (130) disposed within the interior of the body component (110), comprising a plurality of brushes (135) disposed on the plurality of belts (130), configured to move the plurality of brushes (135) throughout the interior of the body component (110) such that the debris is broken down by the plurality of brushes (135) as the plant-supporting medium moves through the body component (110).

2. The device (100) of claim 1 further comprising a motor operatively coupled to the plurality of belts (130), configured to move the plurality of belts (130) upon actuation.

3. The device (100) of claim 1, wherein the body component (110) comprises a stainless steel material.

4. The device (100) of claim 1, wherein the debris comprises roots, sediment, or a combination thereof.

5. The device (100) of claim 1, wherein the plant-supporting medium comprises lightweight expanded clay aggregate (LECA), expanded shale, lava rock, gravel, or a combination thereof.

6. A system (1000) for breaking down debris in a plant-supporting medium, the system (1000) comprising:
a. a masticator device (100) comprising:
i. a body component (110);
ii. an inlet (120) fluidly coupled to an interior of the body component (110), configured to accept the plant-supporting medium; and
iii. a plurality of belts (130) disposed within the interior of the body component (110), comprising a plurality of brushes (135) disposed on the plurality of belts (130), configured to move the plurality of brushes (135) throughout the interior of the body component (110) such that the debris is broken down by the plurality of brushes (135) as the plant-supporting medium moves through the body component (110);
b. a tumbler device (200) fluidly coupled to the masticator device (100) such that the plant-supporting medium exits the body component (110) and enters the tumbler device (200), the tumbler device (200) comprising:
i. a drum component (210) configured to rotate on an axis, the drum component (210) comprising a plurality of slits, configured to allow the debris to exit the drum component (210);
ii. a plurality of spray nozzles (220) disposed within the drum component (210), fluidly coupled to a water source, configured to spray water into the drum component (210) upon actuation such that the plant-supporting medium is cleaned; and
iii. a gate component (230) fluidly coupled to the drum component (210), configured to open and close upon actuation, such that the plant-supporting medium exits the drum component (210) through the gate component (230); and
c. a collection device (300) fluidly coupled to the gate component (230), configured to collect the plant-supporting medium from the drum component (210).

7. The system (1000) of claim 6 further comprising a motor operatively coupled to the plurality of belts (130), configured to move the plurality of belts (130) upon actuation.

8. The system (1000) of claim 6, wherein the body component (110) and the drum component (210) comprise a stainless steel material.

9. The system (1000) of claim 6, wherein the debris comprises roots, sediment, or a combination thereof.

10. The system (1000) of claim 6 further comprising a motor operatively coupled to the drum component (210), configured to rotate the drum component (210) on the axis.

11. The system (1000) of claim 6, wherein the collection device (300) comprises a bin, a hopper, an external device, or a combination thereof.

12. The system (1000) of claim 6 further comprising a plurality of finishing spray nozzles (310) disposed within the collection device (300), fluidly coupled to the water source, configured to spray water into the collection device (300) upon actuation.

13. The system (1000) of claim 6, wherein the plant-supporting medium comprises lightweight expanded clay aggregate (LECA), expanded shale, lava rock, gravel, or a combination thereof.

14. A method for breaking down debris in a plant-supporting medium, the method comprising:
a. feeding the plant-supporting medium into a masticator device (100) comprising:
i. a body component (110);
ii. an inlet (120) fluidly coupled to an interior of the body component (110); and
iii. a plurality of belts (130) disposed within the interior of the body component (110), comprising a plurality of brushes (135) disposed on the plurality of belts (130);
b. actuating the plurality of belts (130) such that the plurality of brushes (135) break up the debris in the plant-supporting medium as the plant-supporting medium moves through the masticator device (100);
c. directing the plant-supporting medium into a tumbler device (200) comprising:
i. a drum component (210) configured to rotate on an axis, the drum component (210) comprising a plurality of slits (215);
ii. a plurality of spray nozzles (220) disposed within the drum component (210), fluidly coupled to a water source; and
iii. a gate component (230) fluidly coupled to the drum component (210);
d. rotating the drum component (210) such that the debris exits the drum component (210) through the plurality of slits (215);
e. spraying the plant-supporting medium by the plurality of spray nozzles (220); and
f. actuating the gate component (230) such that the plant-supporting medium exits the drum component (210) into a collection device (300).

15. The method of claim 14, wherein the masticator device (100) further comprises a motor operatively coupled to the plurality of belts (130), configured to move the plurality of belts (130) upon actuation.

16. The method of claim 14, wherein the body component (110) and the drum component (210) comprise a stainless steel material.

17. The method of claim 14, wherein the tumbler device (200) further comprises a motor operatively coupled to the drum component (210), configured to rotate the drum component (210) on the axis.

18. The method of claim 14, wherein the collection device (300) comprises a bin, a hopper, an external device, or a combination thereof.

19. The method of claim 14 further comprising spraying, by a plurality of finishing spray nozzles (310) disposed within the collection device (300), fluidly coupled to the water source, water into the collection device (300).

20. The method of claim 14, wherein the plant-supporting medium comprises lightweight expanded clay aggregate (LECA), expanded shale, lava rock, gravel, or a combination thereof.
